(19) United States
(12) Patent Application Publication
(10) Pub. No.: US 2026/0273888 A1
(43) Pub. Date: Sep. 17, 2026

(54) A TUBULAR SLEEVE

(71) Applicant: Hariharan KRISHNAN NAIR, Maharashtra Mumbai (IN)

(72) Inventors: Hariharan KRISHNAN NAIR, Maharashtra Mumbai (IN); Gurunath POZHAL VENGU, Karnataka Bangalore (IN)

(21) Appl. No.: 19/167,792

(22) PCT Filed: Mar. 22, 2024
(86) PCT No.: PCT/IN2024/050299

§ 371 Date: Sep. 22, 2025

(30) Foreign Application Priority Data
Mar. 23, 2023 (IN) 202321020590

(51) Int. Cl. B32B 1/08; B32B 27/08; B32B 27/30; B32B 27/32; B32B 38/00; B65D 65/40

(52) U.S. Cl. CPC B32B 1/08; B32B 27/08; B32B 27/306; B32B 27/32; B32B 38/0004; B65D 65/40; B32B 2250/246; B32B 2307/4026; B32B 2307/558; B32B 2307/72; B32B 2307/7376; B32B 2331/00; B32B 2553/00

(57) ABSTRACT

The present disclosure provides a tubular sleeve comprising a polymeric first wall and a polymeric second wall, with a barrier film having one or more layers of polyvinyl alcohol obtained by an extrusion process. The present disclosure provides method of fabrication of the tubular sleeve. The present disclosure further provides a tubular sleeve comprising a polymeric first wall and a polymeric second wall, with a barrier film comprising one or more layers of a polyvinyl alcohol having a thickness in a range of 1 to 15 micron.

### FIELD OF INVENTION

The present disclosure relates to a packaging material. In particular, the present disclosure relates to a tubular sleeve comprising a barrier film, and a process of preparing the tubular sleeve.

### BACKGROUND OF THE INVENTION

Tubular sleeves are layered laminate materials, which has to meet several criteria such as layer integrity, means no separation of the layers during its downstream processing (or) use stage, sufficient barrier to protect the product from several environmental factors like oxygen, moisture, UV light, etc., and still retaining the aroma and stability of the products, etc., The key challenge among these factors is attaining the sufficient barrier performance without increasing the thickness of the barrier layer in-turn the overall sleeve. This is to enhance the sustainability of the tube, so as to maximize the content of a mono-material (single type of polymer) and minimizing the barrier material thereby being advantageous in aspects of recyclability.

Therefore, there is an unmet need in the state of art to develop a multilayered tubular sleeve possessing improved barrier properties at a minimum thickness yet fulfilling the tube sleeve characteristics such as complying to the requirement of burst strength, bond strength with the shoulder, mechanical integrity in drop test, no delamination during downstream processing or use stage, etc., SUMMARY OF THE INVENTION

In an aspect of the present disclosure, there is provided a tubular sleeve comprising a polymeric first wall and a polymeric second wall, with a barrier film having one or more layers of polyvinyl alcohol obtained by an extrusion process.

In another aspect of the present disclosure, there is provided a method of fabrication of the tubular sleeve as claimed in claim 1, the method comprises:
a) independently obtaining the polymeric first wall, the polymeric second wall and the barrier film;
b) laminating together the independent layers of the polymeric first wall, the polymeric second wall and the barrier film to obtain a laminate roll; and
c) slicing the laminate roll into a sheet of width in a range of 63-320 mm, fold seaming the sheet the sheet to obtain the tubular sleeve.

In yet another aspect of the present disclosure, there is provided a tubular sleeve comprising a polymeric first wall and a polymeric second wall, with a barrier film comprising one or more layers of a polyvinyl alcohol having a thickness in a range of 1 to 15 micron.

In still another aspect of the present disclosure, there is provided a tubular sleeve comprising a polymeric first wall and a polymeric second wall, with a barrier film comprising a layer of polyvinyl alcohol obtained by blown film extrusion of polyvinyl alcohol pellets.

These and other features, aspects and advantages of the present subject matter will be better understood with reference to the following disclosure and appended claims. This summary is provided to introduce a selection of concepts in a simplified form. This summary is not intended to identify key features or essential features of the claimed subject matter, nor is it intended to be used to limit the scope of the claimed subject matter.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The term “w/w” means the percentage by weight, relative to the weight of the total composition, unless otherwise specified.

The term “at least one” is used to mean one or more and thus includes individual components as well as mixtures/combinations.

The term “barrier film” refers to the polymeric layer possessing appreciable barrier properties at reduced thickness and has lower oxygen transmission rate placed adjacent to another polymeric material. In the present disclosure, the barrier film having one or more layers of polyvinyl alcohol obtained by an extrusion process. The barrier film also comprises one or more layers of ethylene-vinyl alcohol copolymer, polyamide, polyethylene terephthalate, or combinations thereof.

The term “one or more layers of polyvinyl alcohol” used herein refers to the polyvinyl alcohol obtained by the melt extrusion of granulated/pelleted polyvinyl alcohol. The polyvinyl alcohol exhibits good oxygen barrier properties due to its chemical nature.

The term “ethylene vinyl alcohol copolymer” used herein refers to the hydrolysed copolymer of ethylene and vinyl acetate used as a barrier compound in layered laminates.

The term “polyamide” refer to the polymeric material with amide bond linkage, obtained by capro-lactum ring opening polymerization (or) through the condensation reaction between an amine group and a carboxylic group of the molecules of distinct monomers, generally used for barrier applications in laminates. The polyamides include aliphatic, aromatic, copolymers and blends also.

The term “polyethylene terephthalate” refers to the polymeric resin belonging to the polyester family, obtained by the polymerisation of terephthalic acids and derivatives of such kind. Generally, polyethylene terephthalates are employed as barrier materials for its lower rate of oxygen transmission. The polyethylene terephthalate can also be low melting PET having melting points from (90-210)° C.

The term “blown film extrusion” refers to a process comprising extruding a molten polymer through an annular die and blowing to inflate the polymer to several times of its initial diameter to form a thin polymeric film bubble and collapsing the polymeric bubble to a flat film, which is then converted to articles such as tubes, bags, covers, containers, and pouches.

The term “extrusion lamination” refers to a process in which two or more layers/films are joined together by a molten resin layer extruded between films. This molten resin layer, which joins the films together is termed as “binder layer”.

The term “polymeric first wall” refers to the printable layer that is capable to be configured with a print, colourant, or any ink. The configuration of ink on the film is carried out by employing a process selected from letterpress printing, flexo-ink printing, digital printing, or combinations thereof. The polymeric first wall may be subjected to corona treatment, oxidation, flame treatment or plasma treatment, for the purpose of printing. In the present disclosure, the polymeric first wall comprises at least one ethylene polymer selected from high-density polyethylene (HDPE), medium-density polyethylene (MDPE), low-density polyethylene (LDPE), linear low-density polyethylene (LLDPE) metal-modified polyethylene, chemically modified polyethylene, fiber modified polyethylene, or combinations thereof.

The term “ethylene polymer” used herein refers to a polymeric ethylene selected from a group consisting of high-density polyethylene (HDPE), medium density polyethylene (MDPE), low density polyethylene(LDPE), linear low-density polyethylene (LLDPE), and combinations thereof. The ethylene polymer of the present disclosure has density in a range of 0.910-0.99 g/cm³, preferably in a range of 0.940-0.99 g/cm³ and has melt flow index in a range of 0.5 to 15.0 g/10 minutes.

The term “melt flow index” used herein refers to amount of polymer in grams flowing per 10 minutes through a capillary tube. It is a measure of the ease of flowing of the polymer melt denoted in terms of g/10 min. This is done as per ASTM D 1238.

The term “colorant” refers to the colouring substance added to the tubular sleeve to impart a desired colour and thereby impart an aesthetic feel to the packaging article of tubular sleeve. In the present disclosure, the colorant is selected from titanium dioxide (TiO₂), zinc sulphide (ZnS₂), zinc oxide (ZnO), barium sulfate (BaSO₄), calcium carbonate (CaCO₃) or combinations thereof.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described.

The present disclosure is not to be limited in scope by the specific embodiments described herein, which are intended for the purposes of exemplification only. Functionally equivalent products, compositions, formulations, and methods are clearly within the scope of the disclosure, as described herein.

As discussed in the background, conventionally known tubular sleeves which are layered laminate materials, has to meet several criteria such as layer integrity, means no separation of the layers during its downstream processing (or) use stage, sufficient barrier to protect the product from environmental factors like oxygen, moisture, UV light, etc., retaining the aroma of the products, etc., The key challenge among these factors is attaining the sufficient barrier level without increasing the thickness of the barrier layer in-turn the overall sleeve. This is to enhance the sustainability of the tube, means maximizing the content of a mono-material (single type of polymer) and minimizing the barrier material. Sustainability referred here primarily from a mechanical recyclability perspective.

Polyvinyl alcohol (PVOH) is one of the alternatives employed in the barrier layer to improve the barrier properties with a minimal thickness. However, the major challenge associated with the incorporation of PVOH is its melt process-ability hitherto. On the other hand, if a coating of PVOH is applied, the residual moisture results in peel-ability/delamination, thereby causing severe damage to the packaging material and the product inside it.

Therefore, there is an unmet need in the state of art to develop a multilayered tubular sleeve possessing improved barrier properties at a minimum thickness yet fulfilling the tube sleeve characteristics such as complying to the requirement of burst strength, bond strength with the shoulder, mechanical integrity in drop test, no delamination during downstream processing or use stage, etc.,

To address the issues, the present disclosure provides a tubular sleeve comprising a barrier film of reduced thickness having improved barrier properties. The barrier film of the tubular sleeve comprises a layer of polyvinyl alcohol which is obtained by melt extrusion of granular polyvinyl alcohol. The melt extrusion process can be blown film or cast film. The barrier film can also be further complemented by one or more layers of other barrier components such as ethylene-vinyl alcohol copolymer, polyamides, polyethylene terephthalate, or combinations thereof.

Accordingly, the present disclosure provides a tubular sleeve comprising a polymeric first wall and a polymeric second wall, with a barrier film having one or more layers of polyvinyl alcohol obtained by an extrusion process. The polymeric first wall can also be termed as outer wall and the polymeric second wall also be termed as inner wall depending upon the position in the tubular sleeve.

The present disclosure also provides a tubular sleeve comprising a polymeric first wall, a polymeric second wall and a barrier film having one or more layers of polyvinyl alcohol obtained by an extrusion process. The polymeric first wall, the polymeric second wall and the barrier film can be positioned alternatively. Polymeric first(outer) wall/barrier film/polymeric second (inner) wall; barrier film/polymeric first wall/polymeric second (inner) wall; polymeric first (outer) wall/polymeric second wall/barrier film, and the like. The core layer can be termed as a barrier film. The terms “core”, “barrier film” and “core layer” may be used interchangeably.

### Barrier Film

A tubular sleeve according to an embodiment of the present disclosure, comprises a polymeric first wall (polymeric outer wall) and a polymeric second wall (polymeric inner wall), with a barrier film having one or more layers of polyvinyl alcohol obtained by extrusion process. The core or barrier film as disclosed herein comprises one or more layers of polyvinyl alcohol obtained by extrusion process, particularly by blown film extrusion of polyvinyl alcohol pellets having size commonly adapted for extrusion process. The core or barrier film is adjoined between the polymeric first wall and the polymeric second wall by at least one binder layer.

In an embodiment to the present disclosure, the barrier film is either adjoined with the polymeric first wall or with the polymeric second wall or is sandwiched between the polymeric first wall and the polymeric second wall.

In an embodiment of the present disclosure, the barrier film is adjoined between the polymeric first wall and the polymeric second wall. In another embodiment of the present disclosure, the barrier film is adjoined between the polymeric first wall and the polymeric second wall by at least one binder layer.

In an embodiment of the present disclosure, the polymeric first wall is adjoined between the barrier film and the polymeric second wall. In another embodiment of the present disclosure, the polymeric first wall is adjoined between the barrier film and the polymeric second wall by at least one binder layer.

In an embodiment of the present disclosure, the polymeric second wall is adjoined between the barrier film and the polymeric first wall. In another embodiment of the present disclosure, the polymeric second wall is adjoined between the barrier film and the polymeric first wall by at least one binder layer.

In an embodiment of the present disclosure, the barrier film is adjoined between the polymeric first wall and the polymeric second wall; or the polymeric first wall is adjoined between the barrier film and the polymeric second wall; or the polymeric second wall is adjoined between the barrier film and the polymeric first wall.

In an embodiment of the present disclosure, the core(barrier film) has a monolayer structure. Alternatively, in an embodiment of the present disclosure, the core (barrier film) has a multilayer structure. The layer of polyvinyl alcohol has a thickness less than 15 μm. In another embodiment of the present disclosure, the layer of polyvinyl alcohol has a thickness in a range of 1 to 15 μm.

In an embodiment of the present disclosure, there is provided a tubular sleeve as disclosed herein, wherein the barrier film is sandwiched between at least one first binder layer and at least one second binder layer; the first binder layer is in contact with the polymeric first wall; and the second binder layer is in contact with the polymeric second wall.

In another embodiment of the present disclosure, there is provided a tubular sleeve comprising: a polymeric first wall and a polymeric second wall, with a barrier film having one or more layers of polyvinyl alcohol obtained by extrusion process, one or more layers of ethylene-vinyl alcohol copolymer, polyamides, polyethylene terephthalate, or combinations thereof.

In another embodiment, there is provided a tubular sleeve as disclosed herein, wherein the barrier film comprises one or more layers of polyvinyl alcohol obtained by extrusion process and one or more layers of polyamide; the barrier film is either adjoined with the polymeric first wall or with the polymeric second wall or is sandwiched between the polymeric first wall and the polymeric second wall; the one or more layers of polyvinyl alcohol is in contact with the first binder layer. In another embodiment, the barrier film comprises one or more layers of polyvinyl alcohol obtained by extrusion process and one or more layers of polyamide, wherein the barrier film is sandwiched between at least one first binder layer and at least one second binder layer, and the one or more layers of polyamide is in contact with the first binder layer. In one more embodiment, the barrier film comprises one or more layers of polyvinyl alcohol obtained by extrusion process and one or more layers of ethylene-vinyl alcohol copolymer, wherein the barrier film is sandwiched between at least one first binder layer and at least one second binder layer, and the one or more layers of ethylene-vinyl alcohol copolymer is in contact with the first binder layer.

In an embodiment of the present disclosure, there is provided a tubular sleeve comprising: a polymeric first wall and a polymeric second wall, with a barrier film comprising one or more layers of polyvinyl alcohol obtained by extrusion process, disposed between layers of polyamide.

In an embodiment of the present disclosure, there is provided a tubular sleeve comprising: a polymeric first wall and a polymeric second wall, with a barrier film comprising one or more layers of polyamide disposed between layers of polyvinyl alcohol obtained by extrusion process.

In an embodiment of the present disclosure, there is provided a tubular sleeve comprising: a polymeric first wall and a polymeric second wall, with a barrier film comprises one or more layers of ethylene-vinyl alcohol copolymer disposed between layers of polyvinyl alcohol obtained by extrusion process.

In an embodiment of the present disclosure, there is provided a tubular sleeve comprising: a polymeric first wall and a polymeric second wall, with a barrier film comprises one or more layers of polyvinyl alcohol obtained by extrusion process, disposed between one or more layers of ethylene-vinyl alcohol copolymer.

In an embodiment of the present disclosure, there is provided a tubular sleeve comprising: a polymeric first wall and a polymeric second wall, with a barrier film having one or more layers of polyvinyl alcohol obtained by extrusion process, adjacent to one or more layers of ethylene-vinyl alcohol copolymer.

In an embodiment of the present disclosure, there is provided a tubular sleeve as disclosed herein, wherein when the barrier film is sandwiched between the polymeric first wall and the polymeric second wall, the barrier film is first sandwiched between at least one first binder layer and at least one second binder layer and then sandwiched between the polymeric first wall and the polymeric second wall.

In an embodiment of the present disclosure, there is provided a tubular sleeve as disclosed herein, wherein when the polymeric first wall is adjoined between the barrier film and the polymeric second wall, the polymeric first wall is first sandwiched between at least one first binder layer and at least one second binder layer and then sandwiched between the barrier film and the polymeric second wall.

In an embodiment of the present disclosure, there is provided a tubular sleeve as disclosed herein, wherein when the polymeric second wall is adjoined between the barrier film and the polymeric first wall, the polymeric second wall is first sandwiched between at least one first binder layer and at least one second binder layer and then sandwiched between the barrier film and the polymeric first wall.

The barrier film as disclosed herein is of overall thickness in a range of 1 μm-150 μm having 1-11 layers. The barrier film layer in itself may comprise of its own binder layer and other ethylene polymer layers.

### Polymeric First Wall

A tubular sleeve according to an embodiment of the present disclosure, comprises a polymeric first wall. In an embodiment of the present disclosure, the polymeric first wall comprises at least one layer of ethylene polymer. The at least one ethylene polymer has a melt mass-flow rate in a range of 0.5-15.0 g/10 minutes and a density in the range of 0.910-0.990 g/cm³.

In an embodiment of the present disclosure, the polymeric first wall is the outermost layer of the tubular sleeve which is a printable layer with print properties. In another embodiment of the present disclosure, the polymeric first wall is a middle layer of the tubular sleeve. In another embodiment of the present disclosure, the polymeric first wall is a inner layer of the tubular sleeve. In one embodiment the polymeric first wall comprises at least one ethylene polymer selected from high-density polyethylene (HDPE), medium-density polyethylene (MDPE), low-density polyethylene (LDPE), linear low-density polyethylene (LLDPE) metal-modified polyethylene, chemically modified polyethylene, fiber modified polyethylene, or combinations thereof. In another embodiment the polymeric first wall comprises at least one ethylene polymer selected from high-density polyethylene (HDPE), medium-density polyethylene (MDPE), LLDPE, LDPE or combinations thereof.

In an embodiment of the present disclosure, there is provided a tubular sleeve as disclosed herein, wherein the polymeric first wall comprises at least one layer of ethylene polymer. In another embodiment of the present disclosure, the polymeric first wall comprises a single layer of ethylene polymer. In another embodiment of the present disclosure, the polymeric first wall comprises 2 to 7 layers of the ethylene polymer.

In an embodiment of the present disclosure, there is provided a tubular sleeve as disclosed herein, wherein the polymeric first wall is of thickness in a range of 30 μm-150 μm having 1-7 layers. In another embodiment of the present disclosure, the polymeric first wall comprises at least 3 layers.

In an embodiment of the present disclosure, there is provided a tubular sleeve as disclosed herein, wherein the polymeric first wall is in contact with at least one binder layer.

The polymeric first wall further comprises at least one colourant selected from titanium dioxide (TiO₂), zinc sulphide (ZnS₂), zinc oxide (ZnO), barium sulfate (BaSO₄), calcium carbonate (CaCO₃), or combinations thereof.

### Binder Layer

A tubular sleeve according to an embodiment of the present disclosure, comprises at least one binder layer through which the barrier film, the polymeric first wall and the polymeric second wall are adjoined together. The at least one binder layer may be selected from one or more layers of modified or unmodified alkylene polymer. The term “modified or unmodified alkylene polymer” refers to a polymer comprising alkyl chains which are optionally modified with functional groups or substituents and having a density in a range of 0.930-0.962 g/cm³

The one or more layers of modified or unmodified alkylene polymer is selected from maleated polyethylene, anhydride grafted ethylene/1-butene copolymer, anhydride grafted-(ethylene/1-hexene copolymer, propylene ethylene copolymer), ethylene vinyl acetate copolymer, ethylene methyl acrylate copolymer, anhydride grafted ethylene/1-octene copolymer, LDPE, LLDPE, HDPE, MDPE or combinations thereof. The first binder layer is present in between the barrier film and the polymeric first wall and the second binder layer is present in between the barrier film and the polymeric second wall, when the barrier film is sandwiched between the polymeric first wall and the polymeric second wall. The bottom surface of the first binder layer is in contact with the upper part of the barrier film and the top surface second binder layer is in contact with the lower part of the barrier film. The top surface of the first binder layer is in contact with the polymeric first wall and the bottom surface second binder layer is in contact with the polymeric second wall. The first binder layer is present in between the barrier film and the polymeric first wall and the second binder layer is present in between the polymeric first wall and the polymeric second wall, when the polymeric first wall is sandwiched between the barrier film and the polymeric second wall. The first binder layer is present in between the barrier film and the polymeric second wall and the second binder layer is present in between the polymeric second wall and the polymeric first wall, when the polymeric second wall is sandwiched between the barrier film and the polymeric first wall. The binder layer may be chosen to maximize compatibility with the polymeric first wall or the polymeric second wall thereon and to maximize adhesion between the polymeric first wall, the polymeric second wall and the barrier film.

### Polymeric Second Wall

A tubular sleeve according to an embodiment of the present disclosure, comprises a polymeric second wall. In an embodiment of the present disclosure, the polymeric second wall is the innermost layer of the tubular sleeve which is a sealant layer. In an embodiment of the present disclosure, the polymeric second wall is the middle layer of the tubular sleeve. In an embodiment of the present disclosure, the polymeric second wall comprises at least one layer of ethylene polymer. The at least one ethylene polymer has a melt mass-flow rate in a range of 0.5-15.0 g/10 minutes and a density in the range of 0.910-0.990 g/cm³. In one embodiment the polymeric second (inner) wall comprises at least one ethylene polymer selected from high-density polyethylene (HDPE), medium-density polyethylene (MDPE), low-density polyethylene (LDPE), linear low-density polyethylene (LLDPE) metal-modified polyethylene, chemically modified polyethylene, fiber modified polyethylene, or combinations thereof. In another embodiment the polymeric second wall comprises at least one ethylene polymer selected from high-density polyethylene (HDPE), medium-density polyethylene (MDPE), LLDPE, LDPE or combinations thereof.

In an embodiment of the present disclosure, there is provided a tubular sleeve as disclosed herein, wherein the polymeric second wall comprises at least one layer of ethylene polymer. In another embodiment of the present disclosure, the polymeric second wall comprises a single layer of the ethylene polymer. In one another embodiment of the present disclosure, the polymeric second wall comprises multiple layers of ethylene polymer.

In an embodiment of the present disclosure, there is provided a tubular sleeve as disclosed herein, wherein the polymeric second wall is of thickness in a range of 30 μm-180 μm having 1-7 layers.

In an embodiment of the present disclosure, there is provided a tubular sleeve as disclosed herein, wherein the polymeric second wall is in contact with at least one binder layer.

In an embodiment of the present disclosure, there is provided a tubular sleeve as disclosed herein, wherein the tubular sleeve has density in a range of 0.935-0.990 gm/cm³.

In an embodiment of the present disclosure, there is provided a tubular sleeve comprising: a polymeric first wall of thickness in a range of 30 μm-150 μm having 1-7 layers of ethylene polymer; a polymeric second wall of thickness in a range of 30 μm-180 μm having 1-7 layers of ethylene polymer; and a barrier film of thickness in a range of 1 μm-150 μm having 1-11 layers of polyvinyl alcohol obtained by an extrusion process, one or more layers of ethylene-vinyl alcohol copolymer (EVOH), polyamide, polyethylene terephthalate, or combinations thereof.

In an embodiment of the present disclosure, there is provided a tubular sleeve as disclosed herein, wherein the tubular sleeve in the form of a tube withstands 2 bar pressure for 30 seconds.

In an embodiment of the present disclosure, there is provided a tubular sleeve as disclosed herein, wherein the tubular sleeve has an ovality in a range of 1 to 7%.

In an embodiment of the present disclosure, there is provided a tubular sleeve as disclosed herein, wherein the tubular sleeve has a thickness in a range of 61 μm-400 μm.

In an embodiment of the present disclosure, there is provided a method of fabrication of the tubular sleeve as disclosed herein, the method comprises a) independently obtaining the polymeric first wall, the polymeric second wall and the barrier film; b) followed by laminating together the independent layers of the polymeric first wall, the polymeric second wall and the barrier film to obtain a laminate roll, slicing the laminate roll into a sheet of width in a range of 63-320 mm, and fold seaming the sheet to obtain the tubular sleeve. In another embodiment of the present disclosure, laminating of independent layers of the polymeric first wall, the polymeric second wall and the barrier film is carried out by extrusion lamination. In yet another embodiment of the present disclosure, laminating of independent layers of the polymeric first wall, the polymeric second wall and the barrier film is carried out by adhesive lamination.

In an embodiment of the present disclosure, there is provided a method of fabrication of the tubular sleeve as disclosed herein, wherein each of the layers of polymeric outer(first) wall, the polymeric inner(second) wall and the barrier film independently obtained by blown film extrusion. In another embodiment of the present disclosure, each of the layers of polymeric first (outer) wall, the polymeric second (inner) wall and the barrier film independently obtained by downward extrusion. In another embodiment of the present disclosure, each of the layers of polymeric first wall, the polymeric second wall and the barrier film independently obtained by melt casting.

Although the subject matter has been described in considerable detail with reference to certain embodiments thereof, other embodiments are possible. As such, the spirit and scope of the disclosure should not be limited to the description of the embodiments contained herein.

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein. It is to be understood that this disclosure is not limited to particular methods, and experimental conditions described, as such methods and conditions may apply.

### Example 1

### Process of Preparing the Core/Barrier Film

The core/barrier film was obtained by blown film extrusion of the granular polyvinyl alcohol having particle size in the range of 1 to 15 mm. The granular polyvinyl alcohol was loaded into a hopper and fed into a hot barrel with a screw, wherein the granules were melt-processed. The molten polyvinyl alcohol was then extruded through an annular die. The molten polymer entered the die head and air was injected via a hole in the die center to inflate the molten polymer radially into bubble form, followed by pulling and cooling to obtain the layer of polyvinyl alcohol of thickness less than 15 μm. In another embodiment of the present disclosure, the layer of polyvinyl alcohol has a thickness in a range of 1 to 15 μm. %

In another example, a core-1 (barrier film) was obtained by similar method comprising one layer of polyvinyl alcohol of thickness 5 μm. Similarly, core-2 (barrier film) comprising a layer of polyvinyl alcohol of thickness of 3 μm and core-3 (barrier film) comprising a layer of polyvinyl alcohol (PVOH) and a layer of EVOH of total thickness of 5 μm were obtained. For comparative purpose, core comprising only EVOH of thickness 15 μm was also prepared.

### Example 2

### Preparation of Tubular Sleeve

A process of manufacturing the tubular sleeve comprises the steps of forming the layers and laminating the layers together to form laminates, then slicing into reels of desired width (63 to 320 mm), followed by tubing (sleeve forming and shoulder forming) from the reels.

The tubular sleeve comprised a polymeric outer wall, and a polymeric inner wall layer with a core comprising one or more layers of polyvinyl alcohol obtained by an extrusion process. The polymeric outer wall and the polymeric inner wall were independently obtained by blown film extrusion of at least one ethylene polymer (PE). The core was prepared as explained in Example 1.

Each of said layers were prepared by blown film extrusion as illustrated above, were then laminated by extrusion or adhesive lamination to obtain a laminate roll. The laminate roll was then sliced into a sheet of width in a range of 63-320 mm, and was fold seamed followed by rolling to obtain the tubular sleeve.

The tubular sleeve obtained through extrusion or adhesive lamination with varying core are illustrated in Table 1.

TABLE 1

| | | | | | Polymeric |
|---|---|---|---|---|---|
| | Polymeric first | | | | second |
| | (Outer) wall; | First | Core's | Second | (Inner) wall; |
| | Thickness: | Binder | barrier | Binder | Thickness: |
| Sleeve | 30-150 μm | layer | layer | layer | 30-180 μm |
| Sleeve 1 | PE; | Modified/ | PVOH-3 μm | Modified/ | PE |
| Sleeve 2 | and optionally a | unmodified | PVOH-5 μm | unmodified | |
| Sleeve 3 | colorant | alkylene | PVOH-3 μm/ | alkylene | |
| | | polymer | EVOH-5 μm | polymer | |
| Sleeve 4 | | | EVOH-5 μm/ | | |
| | | | PVOH-3 μm/ | | |
| | | | EVOH-5 μm | | |
| Sleeve 5 | | | PVOH-5 μm/ | | |
| | | | EVOH-3 μm/ | | |
| | | | PVOH-5 μm | | |

In an example the tubular sleeve 250 μm thickness and diameter of 35 mm and length of 170 mm was prepared having the polymeric first wall of thickness 100 μm; the core comprising (5 μm) PVOH of thickness 50 μm and the polymeric second (inner) wall of thickness 60 μm with the binder layers as 20 μm. A comparative tubular sleeve was prepared with the polymeric first (outer) wall of thickness 100 μm; the core comprising (15 μm) EVOH (of thickness 50 μm) and the polymeric second (inner) wall of thickness 60 μm with the binder layers as 20 μm.

### Example 3

### Properties of Tubular Sleeve

The tubular sleeve obtained in Example 2 was subjected to further mechanical and ovality measurements, as listed in Table 2 below.

TABLE 2

| Tubular sleeve | Values |
|---|---|
| Diameter | 35 mm |
| Length | 170 mm |
| Burst Strength | Withstood, 2 Bar for 30 Secs; |
| | No failures observed. |
| Shoulder Bond Strength | Passed |
| Drop Test | Passed |
| Ovality | <6% |

### A. Analysis of Burst Strength

Burst strength refers to the ability of a tube having the tubular sleeve of the present disclosure was held at nozzle, to withstand a higher pressure for a specified time period. The sleeves were held by their nozzle in an air-tight manner in Burst Strength Tester. The pressure was set at 2 bar and held for 30 secs. The tubular sleeves were found to withstand this condition without getting burst for a time period of 30 seconds.

The burst strength test results showed that the prepared tubular sleeves had the ability to withstand internal pressure of about 2 bar without bursting.

### B. Analysis of Shoulder Bond Strength

Shoulder Bond Strength refers to adhesion strength between the shoulder and the sleeve of the tube. When the tube was pulled from the sleeve end (cut in the form of flaps) with shoulder in-between, if the shoulder and the sleeve of the tube do not separate at the ad-joint, instead the sleeve breaks, it indicates the tube has good shoulder bond strength.

The tube was cut diagonally through opposite sides with 15 mm strip and pull tested in a tensile machine/by hand to check the strength/separation behaviour. The strips were found to be tearing without getting separated from the shoulder, which proved the shoulder bond strength and hence had passed the test for shoulder bond strength.

### C. Drop Test:

The tube was filled with products and was dropped from a height of 1.5 meters to check whether it was tearing/cracking. After 3 drops, no leaks, cracks, or tears was observed which confirmed that the tube passed the drop test and was stable enough. Table 3 below summarizes the test results of the tube comprising the tubular sleeve of the present disclosure and the comparative tubular sleeve (CEx-1) comprising 15 μm EVOH as the core. From the below table it could be inferred that the tubular sleeve of the present disclosure having less non-PE may enter in class-A recyclable category as per https://recyclass.eu/recyclability/definition.

TABLE 3

| | Ex-1(5 μm | CEx-1 |
|---|---|---|
| Weight of Component | PVOH) | (15 μm EVOH) |
| Sleeve-(35 dia & 170 mm Length) | 5.15 | 5.15 |
| Shoulder | 1.82 | 1.82 |
| Cap (HDPE Considered) | 4 | 4 |
| Total Weight | 10.97 | 10.97 |
| % NON-PE in sleeve (colorant + | 8 | 12 |
| barrier layer + binder layer) | | |
| % Non-PE in tube | 3.7 | 5.6 |

### ADVANTAGES OF THE PRESENT DISCLOSURE

The present disclosure provides a tubular sleeve comprising a core having one or more layers of polyvinyl alcohol obtained by an extrusion process. The tubular sleeve of the present disclosure has a very small ovality of less than 7% and still exhibits higher mechanical strength to withstand 2 bar pressure for 30 seconds. The tubular sleeve of the present disclosure has a thickness in a range of 61 μm-400 μm and still passed shoulder bond test and drop test. The present disclosure also provides a compatible yet economical extrusion process for the preparation of polyvinyl alcohol layers, one or more layers of which is employed in the core of the tubular sleeve. The sleeves with polyvinyl alcohol in its core possessed better mechanical stability and still desirable structural properties in aspects of thickness and ovality.

1. A tubular sleeve comprising a polymeric first wall and a polymeric second wall, with a barrier film comprising one or more layers of polyvinyl alcohol obtained by an extrusion process.

2. The tubular sleeve as claimed in claim 1, wherein the polymeric first wall and polymeric second wall independently comprises at least one layer of ethylene polymer.

3. (canceled)

4. The tubular sleeve as claimed in claim 1, wherein the barrier film further comprises one or more layers of ethylene-vinyl alcohol copolymer, polyamide, polyethylene terephthalate, or combinations thereof.

5. The tubular sleeve as claimed in claim 1, wherein the tubular sleeve comprises at least one binder layer.

6. The tubular sleeve as claimed in claim 1, wherein the tubular sleeve has density in a range of 0.935-0.990 gm/cm³.

7. The tubular sleeve as claimed in claim 1, wherein the polymeric first wall is of thickness in a range of 30 μm-150 μm comprising 1 to 7 layers.

8. The tubular sleeve as claimed in claim 1, wherein the barrier film is of thickness in a range of 1 μm-150 μm comprising 1 to 11 layers.

9. The tubular sleeve as claimed in claim 1, wherein the polymeric second wall is of thickness in a range of 30 μm-180 μm comprising 1 to 7 layers.

10. The tubular sleeve as claimed in claim 5, wherein the binder layer is selected from one or more layers of modified or unmodified alkylene polymer having density in a range of 0.930-0.962 g/cm³.

11. The tubular sleeve as claimed in claim 2, wherein the at least one layer of ethylene polymer has a melt mass-flow rate in a range of 0.5-15.0 g/10 minutes and a density in a range of 0.910-0.990 g/cm³.

12. The tubular sleeve as claimed in claim 1, wherein the polymeric first wall further comprises at least one colourant.

13. The tubular sleeve as claimed in claim 12, wherein the colourant is selected from titanium dioxide (TiO₂), zinc sulphide (ZnS₂), zinc oxide (ZnO), barium sulfate (BaSO₄), calcium carbonate (CaCO₃), or combinations thereof.

14. The tubular sleeve as claimed in claim 1, wherein the tubular sleeve withstands 2 bar pressure for 30 seconds.

15. The tubular sleeve as claimed in claim 1, wherein the tubular sleeve has an ovality in a range of 1 to 7%.

16. The tubular sleeve as claimed in claim 1, wherein the tubular sleeve has a thickness in a range of 61 μm-400 μm.

17. A method of fabrication of the tubular sleeve as claimed in claim 1, the method comprising:
independently obtaining a polymeric first wall, a polymeric second wall and a barrier film;
laminating together the independent layers of the polymeric first wall, the polymeric second wall and the barrier film to obtain a laminate roll; and
slicing the laminate roll into a sheet of width in a range of 63-320 mm, and fold seaming the sheet to obtain the tubular sleeve.

18. The method as claimed in claim 17, wherein the polymeric first wall, the polymeric second wall and the barrier film are independently obtained by blown film extrusion, downward extrusion, or melt casting.

19. The method as claimed in claim 17, wherein the laminating is carried out by extrusion lamination or adhesive lamination.

20. A tubular sleeve comprising a polymeric first wall and a polymeric second wall, with a barrier film comprising one or more layers of a polyvinyl alcohol having a thickness in a range of 1 to 15 micron.

21. A tubular sleeve comprising a polymeric first wall and a polymeric second wall, with a barrier film comprising a layer of polyvinyl alcohol obtained by blown film extrusion of granular polyvinyl alcohol.
